(19) United States
(12) Patent Application Publication
(10) Pub. No.: US 2005/0129236 A1
(43) Pub. Date: Jun. 16, 2005

(54) Apparatus and method for data source authentication for multicast security

(75) Inventor: Atul Sharma, Westford, MA (US)

Correspondence Address: DARBY & DARBY P.C., P.O. BOX 5257, NEW YORK, NY, 10150-6257, US

(73) Assignee: Nokia, Inc., Irving, TX (US)

(21) Appl. No.: 10/737,595

(22) Filed: Dec. 15, 2003

(51) Int. Cl. H04L 9/00

(52) U.S. Cl. 380/259

(57) ABSTRACT

A method and apparatus for data source authentication in multicast communications is provided. Multicasting a packet may be divided into two actions. The first action includes unicasting the packet from a sending member to a group controller. The second action includes multicasting the packet from the group controller to the multicast group. The packet may be unicast to the group controller with a message authentication code (MAC) that may be generated by encrypting the packet with a symmetric key that is intended to be known only to the sending member and the group controller. After authenticating the MAC, the group controller multicasts the packet to the multicast group. The group controller includes with the packet a separate MAC for substantially each receiving member of the multicast group, each encrypted by a separate symmetric key. Each symmetric key may be intended to be known only by the receiving member and the group controller.

### FIELD OF THE INVENTION

The invention is related to networks, and in particular, to a method and apparatus for multicasting with data source authentication.

### BACKGROUND OF THE INVENTION

There are several different mechanisms for sending or casting packets over a network between one or more nodes, e.g., unicasting, broadcasting and multicasting. In regard to unicasting, packets are sent point-to-point from a single source to a single destination. In regard to broadcasting, packets are sent/broadcast to every node in a network. For multicasting packets are sent to more than one node but less than every node in a network. Often, multicasting mechanisms are employed to communicate packets to members of a group that represent some subset of all of the possible recipients in a network. However, most mechanisms for multicasting have not been as secure as unicasting.

### BRIEF DESCRIPTION OF THE DRAWINGS

Non-limiting and non-exhaustive embodiments of the present invention are described with reference to the following drawings, in which:

FIG. 1 illustrates a block diagram of an embodiment of a multicast group for secure multicasting on a network;

FIG. 2 shows a block diagram of an embodiment of a group controller that is arranged for secure multicasting on a network;

FIG. 3 illustrates a block diagram of another embodiment of a system that is arranged for secure multicasting on a network;

FIG. 4 shows a flow chart of an embodiment of a process for secure multicasting on a network;

FIG. 5 illustrates a flow chart of an embodiment of a process for secure multicasting performed by a sending member;

FIG. 6 shows a flow chart of an embodiment of a process for secure multicasting performed by a group controller; and

FIG. 7 illustrates a flow chart of an embodiment of a process for secure multicasting performed by a receiving member, in accordance with aspects of the present invention.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Throughout the specification and claims, the following terms take at least the meanings explicitly associated herein, unless the context clearly dictates otherwise. The meanings identified below are not intended to limit the terms, but merely provide illustrative examples for the terms. The phrase “in one embodiment,” as used herein does not necessarily refer to the same embodiment, although it may. The meaning of “a,” “an,” and “the” includes plural reference, and the meaning of “in” includes “in” and “on.”

Briefly stated, the invention is related to a method and apparatus for data source authentication in multicast communications. Multicasting a packet may be divided into two actions. The first action includes unicasting the packet from a sending member to a group controller. The second action includes multicasting the packet from the group controller to the multicast group. The packet may be unicast to the group controller with a message authentication code (MAC) that may be generated by encrypting the packet with a symmetric key that is intended to be known only to the sending member and the group controller. After authenticating the MAC, the group controller multicasts the packet to the multicast group. The group controller may include with the packet a separate MAC for substantially each receiving member of the multicast group, each MAC being generated by encrypting the packet with a separate symmetric key. Each symmetric key may be intended to be known only by the receiving member and the group controller.

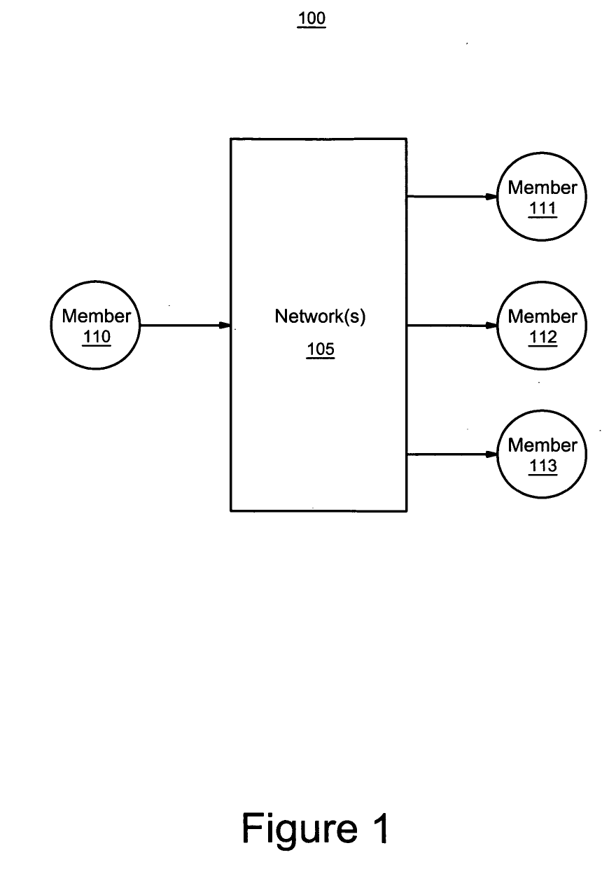

FIG. 1 illustrates a block diagram of an embodiment of system 100. System 100 may be arranged for secure multicasting on a network. System 100 includes members 110-113 of a multicast group, each in communication with network(s) 105.

Network(s) 105 is enabled to employ any form of computer readable media for communicating information from one electronic device to another. In addition, network(s) 105 can include the Internet in addition to local area networks (LANs), wide area networks (WANs), direct connections, such as through a universal serial bus (USB) port, other forms of computer-readable media, and any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network(s) 105 may include any communication method by which information may travel between network devices.

A member (e.g. 110-113) may be any device capable of sending and receiving a packet over a network, and the like, to and from another device. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, and the like. Alternatively, a member may include any device that is capable of connecting using a wired or wireless communication medium such as a PDA, POCKET PC, wearable computer, and any other device that is equipped to communicate over a wired and/or wireless communication medium. Members 110-113 may be configured to communicate packets with another member using a variety of mechanisms.

According to one such mechanism, member 110 may be arranged to multicast a packet. The packet may be multicast such that members, including 111-113, receive the packet. According to one embodiment of system 100, at least four forms of multicast security are provided. These four forms of multicast security include: secure traffic (encryption or integrity protection) for the entire multicast group; automated exchange and management of keying material for the whole multicast group; data source authentication over and above group authentication; and group security policy deployment (policy, specification, distribution, and enforcement).

Data source authentication is provided so that the sending member of the packet may be authenticated. Without data source authentication, even if the other forms of multicast security are provided, it may be possible for one member of the multicast group to spoof the identity of another member of the multicast group.

Data source authentication may be provided by employing a symmetric key. Each of the members 110-113 may employ its own symmetric key. Each symmetric key may be created employing any of a variety of mechanisms. Moreover, at least one symmetric key may be created employing a mechanism that is different from a mechanism employed to generate another symmetric key. In one embodiment, each of the members shares its symmetric key with a group controller (not shown in FIG. 1) as explained in greater detail below.

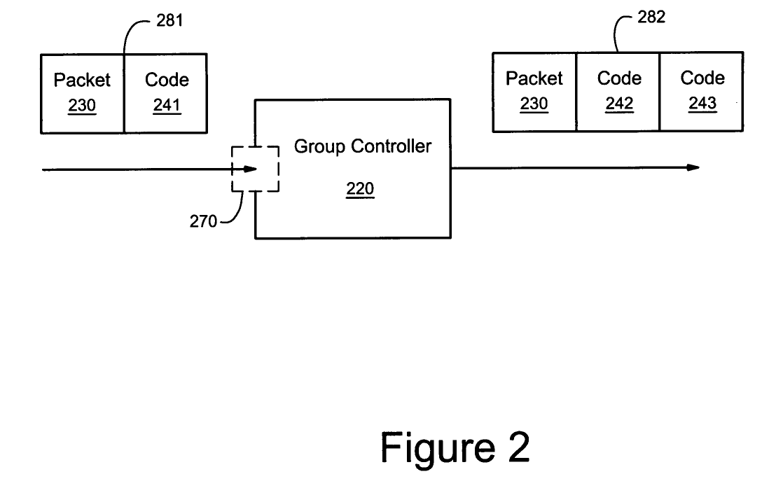

FIG. 2 shows a block diagram of an embodiment of group controller 220. Group controller 220 is arranged for secure multicasting on a network. Group controller 220 includes transceiver 270.

Transceiver 270 is arranged for receiving signal 281. Signal 281 includes packet 230 and code 241. Code 241 is derived from packet 230. Group controller 220 may further include a processor (not shown) for performing actions.

Group controller 220 may be virtually any type of network device. The type of network device that controller 220 may be includes, but is not limited to, a server, a personal computer, a multiprocessor system, a network PC, and the like.

Group controller 220 may be configured to authenticate code 241 with a symmetric key. Group controller 220 may be further configured to drop packet 230 if code 241 is not successfully authenticated. If the code is successfully authenticated, group controller 220 may determine code 242 and 243. Code 242 may be derived, at least in part, from packet 230 using a second symmetric key. Code 243 may be derived, at least in part, from packet 230 using a third symmetric key. After determining codes 242 and 243, group controller 220 may multicast signal 282. Signal 282 includes packet 230, code 242, and code 243.

Codes 241-243 may be message authentication codes (MACs). In one embodiment, the MACs may be cryptographic checksums of packet 230 created by employing the associated symmetric key. In another embodiment, the MACs may be cryptographic checksums of a hash of packet 230 created by employing the associated symmetric key. In other embodiments, Codes 241-243 may also be based on another type of code. Packet 220 may be any set of data arranged in a suitable format for transmission over a network. Packet 220 may correspond to an Ethernet frame, an internet protocol (IP) packet, a segment, a datagram, and the like. Signal 281 may itself be another packet that includes packet 230 and code 241. Similarly, signal 282 may be yet another packet that includes packet 230, code 242, and code 243.

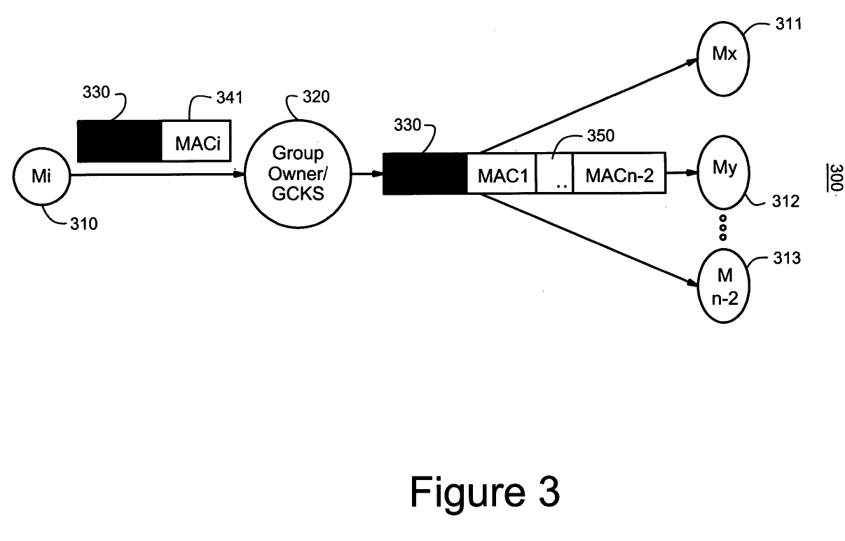

FIG. 3 illustrates a block diagram of another embodiment of a system for secure multicasting on a network. As shown in FIG. 3, system 300 includes members 310-313 and group owner/Group Controller Key Server (GCKS) 320. Group owner/GCKS 320 may also be a member of the multicast group. Group owner/GCKS 320 operate in a substantially similar manner to group controller 220 of FIG. 2. Although five members are shown in FIG. 3, system 300 may include virtually any number, N, of members.

A separate symmetric key may be associated with each member (e.g. 310-313) of the multicast group. Group owner/GCKS 320 may know each of the symmetric keys.

Member 310 may be configured to initiate multicasting of packet 330 by unicasting packet 330 and MAC 341 to group owner/GCKS 320. MAC 341 may be derived, at least in part, from packet 330 by employing a symmetric key that is associated with member 310. In one embodiment, member 310 includes a field associated with packet 330. The field is further associated with an identity of member 310. The field may include an IP address of member 310, some other information that uniquely identifies member 310, and the like.

Group owner/GCKS 320 may be configured to authenticate MAC 341 with the symmetric key that is associated with member 310. Group owner/GCKS 320 may be configured to drop packet 330 if MAC 341 is not successfully authenticated. If MAC 341 is successfully authenticated, group owner/GCKS 320 may determine MACs 350, including a separate MAC for each receiving member (e.g. 311-313) of the packet. The number of MACs 350 determined by group owner/GCKS may be N-2, since N-2 members (e.g. 311-313) may be configured to receive the packet. (In an alternative embodiment, a MAC could also be provided for the sending member, so that N-1 MACs are determined.) After determining N-2 MACs 350, group owner/GCKS 320 may multicast packet 330 and MACs 350. Multicast packet 330 and MACs 350 may be sent to each member of the multicast group.

Members 311-313 may each be configured to receive packet 330 and MACs 350. Each one of members 311-313 may be configured to authenticate the MAC that was generated by encryption with the symmetric key corresponding to that member. For each one of members 311-313, if the MAC associated with that member is not authenticated, the member may drop packet 330.

System 300 may be configured to multicast a packet in two steps. First, member 310 may unicast the packet to group owner/GCKS 320. Second, group owner/GCKS 320 may multicast the packet to the multicast group, including members 311-313. Accordingly, additional routing hops may be required to achieve data source authentication. In one embodiment, the additional routing hops are assimilated into the regular routing hops such that the additional hops are delta addition to the regular routing hops taken by the packet.

Although only one group controller is shown in FIG. 3, one or more group controllers may be included in system 300 without departing from the scope of the invention.

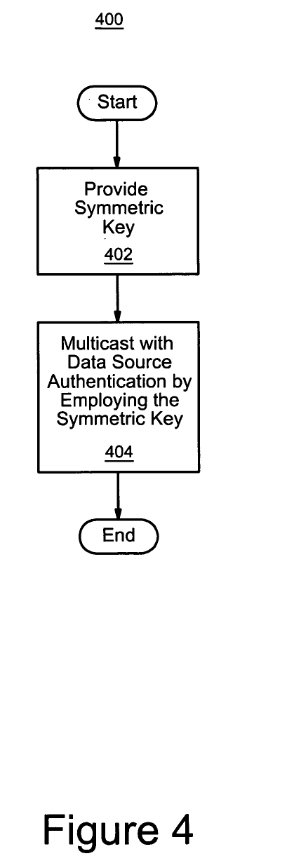

FIG. 4 shows a flow chart of an embodiment of process 400. Process 400 may be for secure multicasting on a network. After a start block, the process proceeds to block 402. At block 402, at least one symmetric key is provided. In one embodiment, the symmetric key is provided by a group controller. According to one embodiment, the symmetric key is provided using an automatic key management system, including at least one of Group Domain of Interpretation (GDOI), Group Secure Association Key Management Protocol (GSAKMP), and the like. In one embodiment, the symmetric key is implemented with Phase-1 of GDOI. According to one embodiment, a separate symmetric key is provided to each member of the multicast group, and each key may be provided only to that member and the group controller. According to another embodiment, the symmetric key may be provided to at least one other member.

In one embodiment, in addition to providing a unique symmetric key to each member, a group key may also be provided to each member. The group key may be known to each group member. The group key may be a group traffic encryption key (GTEK). According to one embodiment, group key encryption is accomplished using multicast encapsulating security payload (MESP). Encryption with the group key is optional, however. Nor is group key encryption needed for data source authentication. However, group key encryption can be employed to encrypt the packet so that only members of the multicast group can decrypt the packet.

Processing then proceeds from block 402 to block 404. At block 404, a packet is multicast to the multicast group. The packet may be multicast such that data source authentication is provided by employing at least one symmetric key. Processing then proceeds from block 404 to an end block.

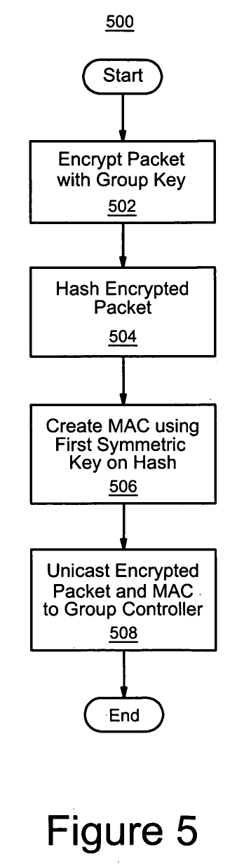

FIG. 5 illustrates a flow chart of an embodiment of a process for secure multicasting performed by a sending member. Process 500 may be performed by one embodiment of member 310 of FIG. 3. After a start block, process 500 may proceed to block 502, where a packet is encrypted with the group key. Block 502 is optional, as discussed previously. After block 502, the process may proceed to block 504, where the encrypted packet is hashed. In one alternative embodiment, hashing need not be performed. Accordingly, block 504 is optional. However, hashing may be used before creating the MAC so that the MAC will be smaller.

The process then proceeds from block 504 to block 506. At block 506, a MAC may be created using a symmetric key on the hash. The symmetric key is associated with the sending member. For example, as shown in FIG. 3, the sending member may be member 310. For an embodiment in which hashing was not employed, the MAC may be created using a symmetric key on the packet.

Process 500 then proceeds from block 506 to block 508, where the encrypted packet and the MAC are unicast to a group controller. The process then proceeds from block 508 to an end block.

According to one embodiment of process 500, the packet includes a field that is associated with the identity of the sending member. The field may include the IP address of the sending member, some other information that uniquely identifies the sending member, and the like.

According to one embodiment discussed previously, the packet is encrypted with the group key, then the encrypted packet is hashed, and then a MAC is generated by employing the symmetric key on the hashed, encrypted packet. In other embodiment, a different order may be employed. For example, in one embodiment, the packet is hashed, then a MAC is generated by employing the symmetric key on the hashed packet, and then the packet and the MAC are encrypted with the group key. In either case, hashing the packet is an optional step that need not be employed, as discussed previously.

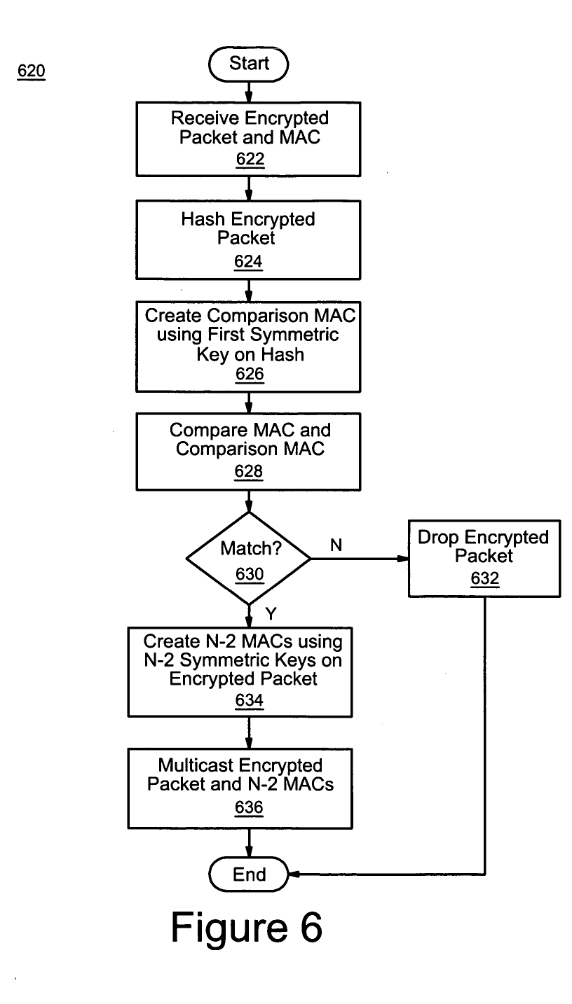

FIG. 6 shows a flow chart of an embodiment of a process for secure multicasting performed by a group controller. Process 620 may be performed by one embodiment of group owner/GCKS 320. After a start block, the process proceeds to block 622. At block 622, the encrypted packet and the MAC are received by the group controller. For example, as shown in FIG. 3, the group controller may be group owner/GCKS 320.

The process may then proceed from block 622 to block 624, where the encrypted packet is hashed. The process then proceeds from block 624 to block 626, where a comparison MAC is derived from the packet using the symmetric key that is associated with the sending member. The process then proceeds from block 626 to block 628, where the MAC and the comparison MAC are compared.

The process then proceeds from block 628 to decision block 630, where a determination is made as to whether the MAC and the comparison MAC are substantially equivalent. As used herein, determining whether two codes are “substantially equivalent” is intended to include embodiments which determine whether two codes are approximately equivalent, as well as embodiments which determine whether two codes are identical. The process proceeds from decision block 630 to block 634 if the MAC and the comparison MAC are substantially equivalent. At block 634, at least N-2 MACs are created using at least N-2 separate symmetric keys on the encrypted packet. Each of the separate symmetric keys is associated with a separate one of the group members that the packet is to be multicast to. The process then proceeds from block 634 to block 636, where the packet and the at least N-2 MACs are multicast. Processing then proceeds from block 636 to an end block.

At decision block 630, if the MAC and the comparison MAC are not substantially equivalent, processing proceeds to block 632. At block 632, the encrypted packet is dropped. Processing then proceeds from block 632 to the end block.

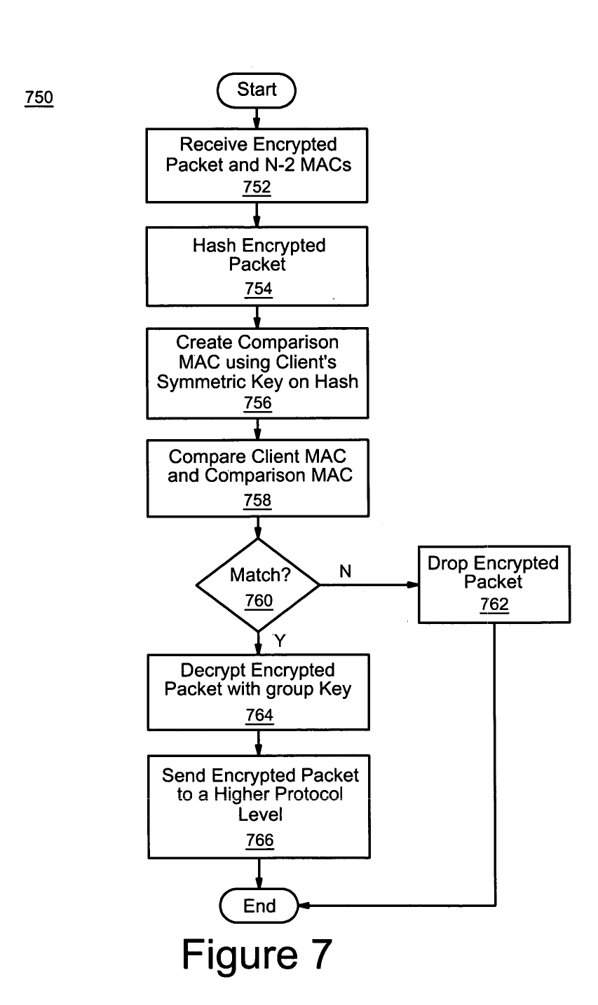

FIG. 7 illustrates a flow chart of an embodiment of process 750. Process 750 may be for secure multicasting performed by a receiving member. Process 750 may be performed by one embodiment of members 311-313. After a start block, the process proceeds to block 752, where the encrypted packet and the at least N-2 MACs are received. The process may then proceed from block 752 to block 754, where the encrypted packet is hashed. As discussed previously, hashing is an optional step that need not be employed. The process then proceeds from block 754 to block 756, where a comparison MAC may be derived from the hash by using the receiving member's symmetric key on the hash. For an embodiment in which the encrypted packet is not hashed, the symmetric key may be derived from the packet by using the receiving member's symmetric key on the packet. The process then proceeds from block 756 to block 758, where the MAC associated with the receiving member and the comparison MAC are compared.

The process then proceeds from block 758 to decision block 760, where a determination is made as to whether the MAC associated with the receiving member and the comparison MAC are substantially equivalent. The process may then proceed from decision block 760 to block 764 if the MAC and the comparison MAC are substantially equivalent. At block 764, the encrypted packet is decrypted with the group key. The process then proceeds from block 764 to block 766, where the decrypted packet is sent to a higher protocol level for further processing. Processing then proceeds from block 766 to an end block.

At decision block 760, if the MAC and the comparison MAC are not substantially equivalent, processing proceeds to block 762. At block 762, the encrypted packet is dropped. Processing then proceeds from block 762 to the end block.

The above specification, examples and data provide a description of the manufacture and use of the composition of the invention. Since many embodiments of the invention can be made without departing from the spirit and scope of the invention, the invention also resides in the claims hereinafter appended.

1. A network device for multicasting a packet over a network, comprising:
a transceiver that is configured to receive a signal that includes the packet and a first code associated with the packet; and
a processor that is configured to perform actions, the actions comprising:
authenticating the first code with a first symmetric key;
if the first code is successfully authenticated, determining a second code derived, at least in part, from the packet and a second symmetric key; and
enabling the packet and the second symmetric key to be multicast to a group of members on the network, wherein at least one member of the group is associated with the second symmetric key.

2. The network device of claim 1, wherein the processor is configured to determine the second code by performing further actions, the further actions comprising:
determining a hash for the packet; and
encrypting the hash with the second symmetric key.

3. The network device of claim 1, wherein the processor is configured to authenticate the first code by performing further actions, the further actions comprising:
determining a hash for the packet;
encrypting the hash with the first symmetric key to provide a comparison code; and
comparing the first code with the comparison code, wherein the first code is successfully authenticated if the first code and the comparison code are substantially equivalent.

4. The network device of claim 1, wherein the processor is configured to perform further actions comprising:
determining a third code associated with the packet, wherein the third code is determined based at least in part on a third symmetric key.

5. The network device of claim 4, wherein the processor is configured to enable the third code to be multicast with the packet and the second code.

6. The network device of claim 5, wherein the first code is a first message authentication code, wherein the second code is a second message authentication code, and wherein the third code is a third message authentication code.

7. The network device of claim 1, wherein the network device is one of the members of the group.

8. The network device of claim 7, wherein the processor is further configured to determine a code for at least two less than a total number of members in the group.

9. The network device of claim 7, wherein the processor is configured to perform further actions comprising:
providing each member a symmetric key, wherein the provided symmetric key is accessible to that member and the network device, and substantially inaccessible to the other members of the group.

10. A system for multicasting a packet over a network, comprising:
a first network device that is configured to determine a first code for the packet with a symmetric key, and is further configured to unicast the packet and the first code to a group controller;
the group controller, wherein the group controller is coupled to the network device, and wherein the group controller is configured to perform actions comprising:
determining the validity of the first code with the symmetric key;
if the first code is valid, determining a second code derived from, at least in part, the packet and a second symmetric key; and
enabling the packet and the second symmetric key to be multicast to a group of network devices on the network; and
a second network device that is one of the members of the group of network devices, wherein the second network device is associated with the second symmetric key and is configured to receive the packet and the second code from the group controller.

11. The system of claim 10, wherein the second symmetric key is accessible to the second network device and is substantially inaccessible to the first network device, and the first symmetric key is substantially inaccessible to the second network device.

12. The system of claim 10, wherein the group controller is a Group Controller Key Server.

13. The system of claim 10, wherein the packet includes a field that is associated with an identity of the first network device.

14. A method for multicasting a packet over a network, comprising:
determining a code for the packet with a first symmetric key;
unicasting the packet and the code to a group controller;
receiving the packet and the code at the group controller;
authenticating the code with the first symmetric key;
if the code is successfully authenticated, determining a second code derived at least in part from the packet with a second symmetric key; and
multicasting the packet with the second code to each member of a group.

15. The method of claim 14, further comprising:
enabling each member of the group to receive the packet and the second code; and
enabling one member of the group to authenticate the second code with the second symmetric key.

16. The method of claim 14, furthering comprising determining separate codes for at least two less than a total number of members in the group.

17. The method of claim 14, further comprising providing each member with a corresponding symmetric key, wherein each symmetric key is accessible to the corresponding member and the group controller and substantially inaccessible to every other member in the group.

18. The method of claim 14, wherein providing the symmetric key is accomplished by employing an automated key management system, and wherein the automated key management system comprises at least one of Group Domain of Interpretation and Group Secure Association Key Management Protocol.

19. An apparatus for multicasting a packet over a network, comprising:
means for authenticating a first code with a first symmetric key, wherein the first code was derived, at least in part, from the packet and the first symmetric key;
means for determining a second code derived, at least in part, from the packet and a second symmetric key if the first code is successfully authenticated; and
means for enabling the packet and the second symmetric key to be multicast to a group of members on the network, wherein at least one member of the group is associated with the second symmetric key.
